(19) United States
(12) Patent Application Publication
(10) Pub. No.: US 2016/0098706 A1
(43) Pub. Date: Apr. 7, 2016

(54) METHOD AND APPARATUS FOR CONDUCTING FUND TRANSFER BETWEEN TWO ENTITIES AND ITS APPLICATION AS A CELL PHONE WALLET

(71) Applicant: Marvin T. LING, Scottsdale, AZ (US)

(72) Inventor: Marvin T. Ling, Scottsdale, AZ (US)

(21) Appl. No.: 14/892,021

(22) PCT Filed: May 15, 2014
(86) PCT No.: PCT/US14/38086

§ 371 Date: Nov. 18, 2015

Related U.S. Application Data
(60) Provisional application No. 61/863,773, filed on Aug. 8, 2013.
(60) Provisional application No. 61/928,174, filed on Jan. 16, 2014.

(51) Int. Cl. G06Q 20/36; G06Q 20/42; G06Q 20/32

(52) U.S. Cl. CPC G06Q 20/36; G06Q 20/3223; G06Q 20/42

(57) ABSTRACT

A process of transferring funds between two entities or persons is described; the process includes transferring funds from person A to-person B and reversing the process allowing refunds. The processes are performed through a Universal Vendor Management Server (UVM) where both entities A and B are registered and have opened UVM accounts. The funds transfer and refund processes permit the transfer of funds between the respective accounts and the charging of service fees to the entity initiating the transfer or refund process. No third party other than the UVM operator is involved in the transactions such as banks, credit card companies, and the like. The funds transfer may be achieved utilizing a cell phone to make a purchase at a participating vendor. A person enters an amount of payment in the cell phone; the amount is subtracted from the purchasers account and added to the account of the vendor.

### RELATED APPLICATIONS

This application is related to and claims priority to a PCT application entitled “METHOD AND APPARATUS FOR CONDUCTING OFFLINE COMMERCE TRANSACTIONS” filed May 20, 2013, and assigned Serial No. PCT/US2013/041870; a provisional application entitled “FUNDS TRANSFER SYSTEM” filed Aug. 8, 2013, and assigned Ser. No. 61/863,773; and a provisional application entitled “METHOD AND APPARATUS FOR CONDUCTING FUND TRANSFER BETWEEN TWO PERSONS AND ITS APPLICATION FOR CELL PHONE WALLET” FILED Jan. 16, 2014, and assigned Ser. No. 61/928,174.

### FIELD OF THE INVENTION

The present invention relates to methods and apparatus for conducting funds transfers between two entities using email addresses, cell phone numbers or a User ID Barcode of each of the two entities. The entities are typically individual persons but may be organizational entities such as a Vendor.

### BACKGROUND OF THE INVENTION

There are many situations wherein a person desires to transfer funds to another person. For example, a person may want to lend money to, or pay back a loan from a friend; similarly, the situation may occur when buying or selling between entities or the payment of the services from one person received from another. A typical case requiring the transfer of funds between two entities involves auctions. Entity A will pay Entity B for goods that Entity B offered in an auction. The payment for an auction involves the funds transfer between the Buyer and the Seller; the amount of money involving the fund transfer in the present invention may be any amount including small amounts less than a dollar. The device that an entity uses under the present invention for the transfer of funds may include a cell phone, a tablet, a personal computer, or other similar device. The transfer of funds from one entity to another can be accomplished online or offline. An entity can transfer the money to the other through a bank; however, the transfer of funds using a bank takes substantial amount of time and will include bank fees. Further, the party receiving the funds transfer is often required to withdraw the money at the bank at their convenience. Usually, fund transfers using banks are related to relatively large sums of money.

There are systems presently available in the prior art that involve the transfer of money from one person to another; for example, one system allows a customer to pay for a beverage using a cell phone. In the latter case, the customer takes a picture of the sales amount as displayed in the cash register using a cell phone camera; the cell phone is downloaded with a software app that will analyze the picture taken and determine the sales amount. The software performs an optical character recognition process on the text within the picture taken from the cash register. This process is very cumbersome, slow, and is essentially very inconvenient.

Another prior art system is a global e-commerce business allowing payments and money transfers from a person to a vendor. This latter system requires the user to download an app into a cell phone that has an NFC chip. This allows the user to shop with a single tap at the vendor's site having an NFC reader; the system charges a seller a fee of the total sale amount plus a fixed transaction fee. This system can also link a user's bank account, debit or credit card account.

### SUMMARY OF THE INVENTION

The present invention provides for the transfer of funds between two entities. As indicated previously, the entities may be individuals or organizational entities such as vendors. Persons desiring to transfer funds to another person, or to receive funds being transferred by the other party, register at a User Vendor Management Server (UVM) and open a UVM account.

The User Vendor Management Server (UVM) is a server system managed and operated by an entity for the purpose of establishing accounts with users (which can be any entity, person, or organization). The operating company thus manages and controls the UVM and contracts with users and using entities to receive and establish funds in designated accounts; funds can be added to and subtracted from these accounts in accordance with the rules and regulations contractually established between the operating entity and the user. Thus, funds may be placed into an account, withdrawn from the account, transferred to another account, or manipulated in any manner in accordance with the contractual relationship established between the operator and the user. Funds can be placed into an account by a user using any convenient and conventional methods such as a credit card, check, electronic funds transfer from a financial institution and the like. The condition of and the details of any account may be accessed by the account's user through any means chosen in accordance with the agreement between the operator and the user; for example, the account details may be accessed by the user through conventional website or interne communication.

The UVM can manage accounts either in a prepaid mode or a postpaid mode. In the prepaid mode, the user will be required to make a certain initial deposit (provide an amount of electronic funds) using the user's credit card as determined by the company operating the UVM. This initial deposit is called the “Top Off” amount. The UVM can manage accounts in a post-pay system; in the latter system, the UVM operator grants the registered user a certain amount of Available Credit which may be in a limited amount which is called “Negative Top Off Amount”.

Upon completing the user registration, the UVM will issue a User ID Barcode for the registered entity or person. A User ID Barcode includes a Country Code, a Company Code, and a User Index in addition to the User ID. The inclusion of the Country Code allows any company in the world to issue the User ID Barcode. The inclusion of the Company Code allows any company in any country to issue the User ID Barcode. The User Index as used in the present invention identifies the specific encryption algorithm in a table of thousands of encryption algorithms maintained by the UVM that is used to encrypt the User ID. The User ID can be a credit card number, a cell phone number or any other number that uniquely identifies the user.

The User ID Barcode can be distinguished from product barcodes that may be sold at vendor sites. The User ID Barcode is prefixed with a special character such as a “?” before it is converted into barcode format to thus signal that the information is an ID Barcode rather than a product code. The User ID Barcode may be downloaded into a cell phone or printed on the back of a credit card or any other similar media such as a stick-on label that can be presented to a barcode reader.

Upon completing the required registration, the UVM creates the User ID Barcode and, if the UVM is being operated by a phone company, permits the download of the User ID Barcode to the user's cell phone. If a credit card company is operating a UVM, a new credit card may be issued to the user with the User ID Barcode printed on the back of the card. It may be noted that the transfer of funds utilizing the present invention does not require the involvement of financial institutions such as banks, the utilization of which may include additional regulation, accounting, and similar operations or services resulting in an increase cost and complexity of the transaction. When the method and apparatus of the present invention for the transfer of funds between two entities utilizes a cell phone, it essentially renders the cell phone a “Cell Phone Wallet”.

### BRIEF DESCRIPTION OF THE DRAWINGS

The present invention may more readily be described by reference to the accompanying drawings in which:

FIG. 1 is a functional block diagram useful in the description of a funds transfer transaction between two individuals.

FIG. 2 is a functional block diagram useful in the description of a funds transfer transaction between two individuals wherein a fund reversing function is implemented.

FIG. 3 is a functional block diagram useful in the description of a funds transfer transaction between two individuals wherein misrepresentation may be present.

FIG. 4 is a functional block diagram useful in the description of a funds transfer transaction in a purchasing environment between a customer and a vendor.

FIG. 5 is a schematic illustration of a User ID Barcode

### DETAILED DESCRIPTION OF THE INVENTION

Reference may be had to the above identified related applications; the descriptions therein may be helpful in the complete understanding of terminology used in the relevant industry and embodied in the present description.

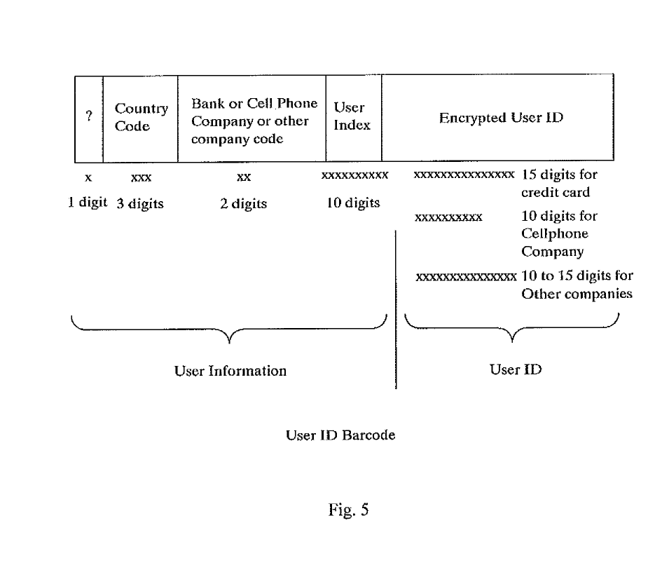

The User ID Barcode identifies the user and provides the user a convenient means for communicating in the process of making purchases of goods and services. The barcode, as used herein, refers to the typical optical machine-readable representation of data. The code usually identifies data concerning the object to which it is attached and is represented by varying widths and spacings of parallel lines. The data contained in the barcode is read by conventional barcode readers or scanners that optically recognize the spacing and width of the parallel lines to derive data concerning the article to which the code is attached. The User ID Barcode uniquely identifies the user. A number unique to a user such as the user's credit card number or a cell phone number may form the basis of the User ID Barcode. FIG. 5 is an illustration of the User ID Barcode that may be utilized in the present invention. Referring to FIG. 5, the User ID Barcode has a “?” as a prefixed character which indicates to a vendor server that the barcode is the User ID Barcode, and not a product barcode. The User ID Barcode consists of four fields. The first field is the country code which utilizes three digits so that it can refer to any selected country in the world. The second field comprises two digits representing the Company Code. Thus, up to 99 companies in any designated country may be identified. This field can be expanded if there are more than 99 companies in the country that will issue the User ID Barcode. The third field is the User Index which points to one of the encryption algorithms within the table of encryption algorithms maintained by the UVM of the operating company which issue the User ID Barcode to the user. The fourth field contains the User ID encrypted with the encryption algorithm as specified by the User Index. The first, second and third fields contain User Information that is not encrypted. This User Information is used to retrieve the User's UVM account.

As indicated above, the encryption algorithm for the User ID Barcode may be selected for individual users to render the encryption algorithm “user variant”. The encryption algorithm can be changed with time to provide an additional level of security for the user. Since the algorithm can be changed with time, the encryption algorithm is also “time variant”. The present invention also provides a User Index which identifies the encryption algorithm that is used to encrypt the user's unique number, the User ID. The User Index points to a very large table of encryption algorithms maintained by the UVM to accommodate user variant and time variant encryptions. When the User ID Barcode is generated from a credit card number and subsequently printed on the back of the credit card, the credit card becomes a “two-in-one” card; that is, the credit card may be used in the typical magnetic strip fashion that is “swiped” through a magnetic reader or may be scanned using a barcode reader.

A significant feature of the present invention is the rapidity with which the process of purchasing by the user is accommodated. Normally, a purchasing process using the User ID Barcode can be completed in one or two seconds. The result is faster checkout time for the establishment and cashier and provides the user with convenience. Potentially, the rapidity with which the transaction is accomplished may allow the vendor to reduce the number of cashiers and therefore reduce the vendor's operating costs.

Referring to FIG. 1, a funds transferring event is shown wherein an entity such as a person using an email address or the User ID Barcode or the cell phone number of the person is involved. In step 1, person A informs the UVM that they would like to send a specified amount of money to person B using the available funds in person A's UVM account. In step 2, the UVM subtracts the equivalent amount of available funds in person A's account, plus the UVM service fee. The UVM holds the amount of funds and service fee in escrow to enable the investigation of person A's account to assure there are sufficient funds for the completion of the transfer. In step 3, the UVM informs person B that person A intends to transfer funds to person B's account using the UVM and requests permission from person B to receive the funds. Assuming that person B agrees to the receipt of the transfer of funds into person B's UVM account, step 4, the UVM deposits the funds in the person Ws UVM account, step 5; in step 6, if person B desires to withdraw the transferred funds, they may exchange the UVM funds as indicated above for cash from a participating bank. In the event person B replies to the UVM that they decline to accept the funds from person A, the transaction process is concluded.

When the entities or persons using the present system use their own User ID Barcode to communicate with the UVM funds transfer, the system allows either party to perform the fund transfer in any country in the world having one or more UVMs in operation. The User ID Barcode contains the Country Code, the Company Code, allowing the UVM operator to charge the person sending money and credit the person receiving money by locating the respective UVM where the entities or persons A and/or B are registered and have their UVM accounts. Furthermore, the UVM can easily take into account the currency exchange considerations wherein currency exchange rates between countries may be accounted for in the funds exchange. The UVM records the detailed fund transfer and receiving transactions with the exchange rate at the time of the transactions.

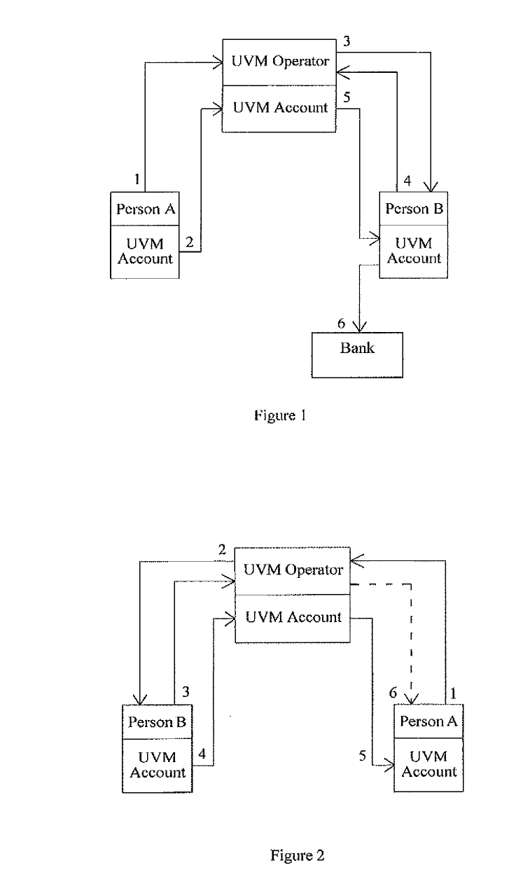

Referring now to FIG. 2, a transaction process is shown that allows person B to refund person A the funds transferred from A to B as described in FIG. 1. The reversing system transaction is necessary in those instances for example where the transaction includes the purchase of goods. In the event that person A believes that the goods purchased are not as represented or for other reasons are not needed or wanted, the items purchased from person B may be returned and the funds refunded to the purchaser. Referring to FIG. 2, person A requests person B for a refund through the UVM as shown in step 1. In step 2, the UVM informs person B that person A requests a refund and asks person B to agree to such transaction. Person B informs the UVM that they agree to the refund as shown in step 3. In step 4, the UVM subtracts the amount to be refunded from person B's account and adds the same amount, minus a service fee, to person A's account as shown in step 5. In step 6, the UVM informs person A that the refund has been made and that the refund transaction is complete.

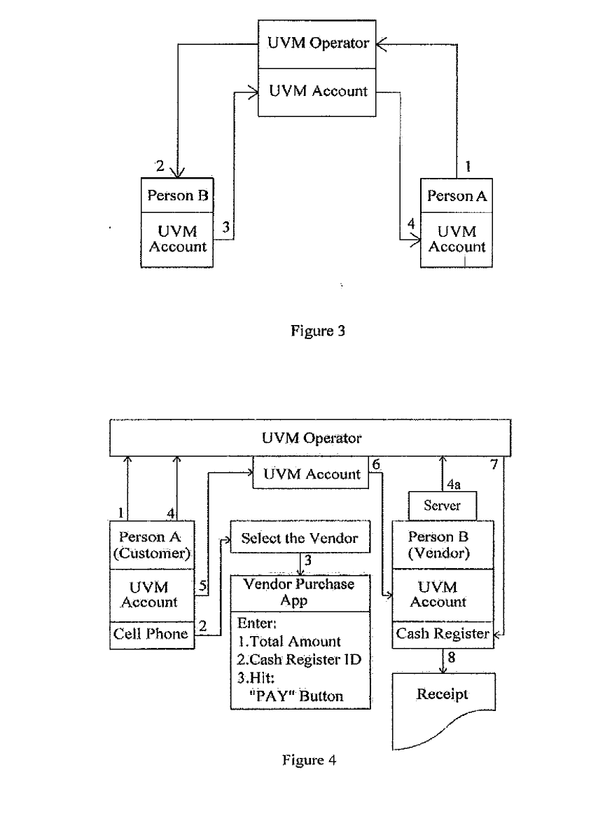

In the event of a material misrepresentation or fraud, FIG. 3 describes the transaction process that may take place following the payment process that had preceded it in accordance with FIG. 1. Misrepresentations and frauds in person-to-person transactions have frequently been reported when the purchasing transaction is the result of an auction or on-line purchasing of goods described at a seller's or vendor's website. Referring to FIG. 3, in step 1, person A informs the UVM that the goods he or she purchased from person B is not as represented and that the misrepresentation appears to be deliberate and perhaps fraud committed by person B. The UVM subsequently notifies person B, step 2, of the allegations received from person A and subtracts the amount of the funds, step 3, from person B's UVM account to person A's account, step 4. The evaluation of the misrepresentation and fraud may take several forms and will likely be the result of an algorithm prepared by the UVM for handling such situations. The evaluation and investigation may include the report of the situation to authorities and request assistance or investigation of the situation. In the event the misrepresentation is genuine, the UVM will start monitoring person B's transactions and possibly suspend future transactions involving person B's account.

In those instances wherein person A uses a cell phone for a purchasing transaction and person B is a vendor or merchant having a typical cash register with a cash register ID, the present method and apparatus provides a unique method for the payment of purchases at a merchant's site using a cell phone with the result that the customer's (person A) cell phone effectively becomes a cell phone wallet.

Referring to FIG. 4, a description of a purchasing process using such cell phone wallet is illustrated. The cell phone is provided with the purchaser's user ID barcode such as may be displayed in the cell phone window or label secured to the phone. For purposes of describing the process of FIG. 4, the vendor may be a typical merchant and will be referred to as a merchant or vendor. In step 1 of FIG. 4, person A logs into the UVM. In step 2 that person selects the vendor or merchant where the purchase is to be made from among a list of vendors provided by the UVM. Each of these vendors have established accounts with the UVM and have plural cash registers each with an individual identification (ID). Each such vendor or merchant has a purchasing app that is available online. Upon selecting the merchant, in step 3 the merchant's purchasing app will be displayed on the purchaser's cell phone prompting the purchaser to enter the total purchase price amount of the purchase and the cash register identification. When the cashier completes scanning all products to be purchased by person A, person A enters the total purchase price amount of the purchase and the merchant cash register ID and then activates a “pay” button as displayed on person A's cell phone. The cell phone sends the purchase data to the UVM (step 4). The cash register ID's of each participating merchant may be stored in the UVM allowing the user to select the cash register where the user makes the payment. Note that this payment does not provide the user, person A, with a detail of goods purchased except from sales receipt which the cash register prints out and gives to the customer. In this embodiment, the cash register is provided with a means to receive the cell phone “pay” signal. Thus, the cash register receives a signal for approving the payment, step 7, and proceeds to print the register receipt with the identification of the goods thereon.

Alternatively, the cashier scans the user ID barcode provided by person A for the payment of goods being purchased; upon detection by the merchant server of the special character that indicates the scanned code is a user ID barcode and not a product code, the user ID, the name of the merchant, the total purchase price amount, and the cash register ID are forwarded through the merchant server to the UVM (step 4a). Upon receiving the above information, the UVM subtracts the total amount from person A's UVM account as shown in step 5. The UVM then subtracts a vendor service fee as agreed earlier between the UVM operator and the manager of the Merchant server and then deposits the remaining amount into the merchant's UVM account step 6. In step 7 the UVM sends “Approved” signal to the merchant's cash register as specified by the cash register ID and in Step 8, the cash register prints out the receipt which lists a brief description of each of the items being purchased and the total amount of the purchase to complete the purchasing payment process. Thus, the use of the cell phone as a cell phone wallet permits the purchaser to utilize a cell phone to directly purchase goods and transfer funds from the purchaser's UVM account to the merchant's UVM account and signal to the merchant's cash register the necessary information to permit the cash register to print a receipt.

If the cash register IDs of each participating merchant is stored in the merchant's server which maintains among other things, the complete list of products being sold by the merchant, then when the cash register and UVM establishes the link and person A activates the “Pay” button on the cell phone, the UVM sends the “Approved” signal to the cash register through the merchant's server. Upon receiving the “Approved” signal, the cash register sends the complete list of purchases made by person A to the UVM through the merchant's server and prints out the sales receipt that completes the purchasing transaction. The UVM stores person A's detailed purchasing transaction data into person A's UVM account which the UVM maintains for all registered users. Person A may then view the data stored in the UVM account by simply logging into the UVM and following the usual procedure for access to his account. If the merchant is very small, they may have only a single cash register and may not have an independent server. In such cases, a cash register ID is not required and the merchant server may actually be a server hosted by others for the use and benefit of the merchant.

It is expected that person A will store several merchant IDs where person A makes frequent purchases with the cell phone. This allows the customer to select merchant ID, cash register ID's and even may activate the “Pay” button within the cell phone wallet prior to entering a checkout line. When the purchaser reaches the merchant register for checkout, entering the total purchase price amount will activate the purchasing process resulting in the printing of the necessary receipt document for delivery to the purchaser at the register. The system thus is extremely efficient and represents a significant time savings in the checkout process both as convenience to the purchaser and to lowering of expenses for the vendor.

It is desirable that the merchant or vendor server be equipped with a feature allowing the process to search for the pending transactions within the merchant server using the total amount of the purchases. This eliminates the need for person A to identify and enter the cash register ID and it further simplifies and expedites the checkout process. It is also desirable that the merchant server allows the process to search for the pending transaction based on the cash register ID without the need for person A to enter the total amount of the purchases and complete the purchasing transaction. This will further simplify and expedite the checkout process.

The payment method described herein uses a regular cell phone without requiring any special hardware such as an NFC chip or downloading any special software into the customer's cell phone. In contrast, prior art payment methods using cell phones are often restricted to special merchant sites that have equipment or special software to accept the customer's payment using their cell phones.

The present invention has been described in terms of selected specific embodiments of the apparatus and method incorporating details to facilitate the understanding of the principles of construction and operation of the invention. Such reference herein to a specific embodiment and details thereof is not intended to limit the scope of the claims appended hereto. It will be apparent to those skilled in the art that modifications may be made in the embodiments chosen for illustration without departing from the spirit and scope of the invention.

What is claimed:

1. A method for conducting fund transfer transactions between two entities utilizing the internet comprising:
(a) providing a user vendor management server (UVM);
(b) creating an account on said UVM for each entity A and B using their respective cell phone number, email address, or User ID Barcode for identification;
(c) receiving funds deposits from each entity to create available funds in its respective account;
(d) receiving directions from entity A directing an operator of the UVM to transfer funds from entity A's account to entity B's account;
(e) deducting funds from entity A's account in accordance with entity A's directions plus a service fee;
(f) directing an inquiry to entity B if the latter will accept funds from entity A; and
(g) transferring funds into B's account in response to B's acceptance of the transferring funds.

2. The method of claim 1 wherein the funds in the A and B accounts may be Top Off Amounts or Negative Top Off Amounts.

3. The method of claim 1 including:
(a) receiving a request for refund from entity A;
(b) directing an inquiry to entity B if entity B agrees to a refund; and
(c) transferring funds to be returned to entity A's account from entity B's account.

4. A method for conducting fund transfer transactions between two entities using the Internet comprising:
(a) providing a user vendor management server (UVM);
(b) creating an account on said UVM for each entity A and B wherein entity A is a purchaser having a cell phone and entity B is a merchant having a purchasing app, and having a cash register;
(c) receiving funds deposits in the UVM from entity A to create available funds in its respective UVM account;
(d) establishing a list of merchants in the UVM, each merchant having a UVM account;
(e) receiving in the UVM a merchant selection of merchant B from entity A's cell phone from among the list of merchants provided in the UVM;
(f) providing merchant B's purchasing app to entity A′ cell phone in response to said merchant selection;
(g) receiving in the UVM a total purchase price amount from entity A as entered by entity A in and displayed on entity A's cell phone;
(h) receiving in the UVM a pay authorization signal from entity A's cell phone;
(i) subtracting the total purchase price amount from entity A's account and adding that purchase price to entity B's account less vendor management service fees; and
(j) providing an approval signal from the UVM to the cash register indicating successful transfer of funds into Merchant B's account.

5. A method of claim 4 for conducting fund transfer transactions between two entities using the internet including:
(a) providing a complete list of purchases made by entity A to the UVM from the cash register.

6. A method for conducting fund transfer transactions between two entities using the internet comprising:
(a) providing a user vendor management server (UVM);
(b) creating an account on said UVM for each entity A and B wherein entity A is a purchaser having a cell phone and entity B is a merchant having a merchant server, a purchasing app, and having cash registers with individual ID's;
(c) receiving funds deposits in the UVM from entity A to create available funds in its respective UVM account;
(d) establishing a list of merchants in the UVM, each merchant having a UVM account;
(e) receiving in the UVM a merchant selection of merchant B from entity A from among the list of merchants provided in the UVM;
(f) providing merchant B's purchasing app to entity A in response to said merchant selection;
(g) receiving in the UVM a cash register selection from entity A of the cash register ID and total purchase price amount from entity A as entered in and displayed on entity A's cell phone;
(h) receiving a pay authorization signal from entity A's cell phone;
(i) subtracting the total purchase price amount from entity A's account and adding that purchase price amount to entity B's account less vendor management service fees;
(j) providing an approval signal from the UVM to the cash register through merchant B's server indicating successful transfer of funds into merchant B's account; and
(k) providing a cash register printed sales receipt to entity A.

7. The method of claim 6 including:
providing a complete list of purchases made by entity A to the UVM from the cash register through merchant B's server.

8. A method for conducting fund transfer transactions between two entities using the internet between two entities comprising:
(a) providing a user vendor management server (UVM);
(b) creating an account on said UVM for each entity A and B wherein entity A is a purchaser having a cell phone with a user ID barcode available on the cell phone and entity B is a merchant having a merchant server;
(c) receiving funds deposits in the UVM from entity A to create available funds in its respective UVM account;
(d) scanning product barcodes on products being purchased by entity A to develop purchasing data including product description and price;
(e) forwarding said purchasing data to merchant B's server;
(f) scanning entity A's user ID barcode on entity A's cell phone;
(g) forwarding entity A's user ID barcode to merchant B's server and to said UVM;
(h) subtracting the total purchase price amount from entity A's account and adding that purchase price amount to entity B's account less vendor management service fees;
(i) providing an approval signal from the UVM to the cash register through merchant B's server indicating successful transfer of funds into merchant B's account; and
(j) providing a cash register printed sales receipt to entity A.

9. A method of claim 8 for conducting fund transfer transactions between two entities using the Internet wherein said user ID barcode includes a special character to distinguish the user ID barcode from product bar codes.
